(19) United States
(12) Patent Application Publication
(10) Pub. No.: US 2019/0327943 A1
(43) Pub. Date: Oct. 31, 2019

(54) Vertical Frame Orientation Bee Container

(71) Applicant: David Wayne Huva, II, Charlotte, MI (US)

(72) Inventor: David Wayne Huva, II, Charlotte, MI (US)

(21) Appl. No.: 15/964,610

(22) Filed: Apr. 27, 2018

(51) Int. Cl. A01K 47/02

(52) U.S. Cl. CPC A01K 47/02

(57) ABSTRACT

The Vertical Frame Orientation Bee Container is unique in that it allows for positioning of Langstroth bee hive frames in said container in the vertical frame position and allows access to said frames without removal of any hive body or super above, or requiring movement of the container (excluding covers) on any axis, with the best embodiment having dimensions that allow it to be used interchangeably with Langstroth type hive bodies, supers, compatible hives, and most devices for Langstroth hives. It also adds features that are designed to allow for ease in separating propolized components from each other while limiting any damage to the container constituents.

### FIELD OF THE INVENTION

The current invention relates to the keeping of bees. In particular, a man-made container used to house removable frames.

### BACKGROUND OF THE INVENTION

Current man-made designs of bee hives primarily use stacked containers, usually called bodies or supers, to hold a plurality of removable frames in the horizontal frame position for the bees to build their hive in. There are also hives built longitudinally, with or without an option to stack the hive components, that use a plurality of removable frames in the horizontal frame position.

Stacked type hives usually contain eight to ten frames inside each container, but vary by beekeeper and design. When loaded with honey, the containers can weigh 50 to 90 pounds each. Highly productive hives can exceed five stacked containers, reaching over 5 feet in height. The upper containers must be removed to check the lower containers or to harvest the honey. Physically this is very demanding and potentially dangerous due to the weight and thousands of bees inside the containers. Moving the containers is disruptive to the bees and causes wear to the containers and other accessories in use. There have been various designs for beehives and systems that attempt to address this situation, but they are typically highly proprietary in their equipment and offer limited expandability or compatibility with the most commonly used designs, if any.

The Langstroth style hive is the most commonly used type of hive system at this point in time. Within the Langstroth hive type there are two common styles, the 8-frame and the 10-frame. Only the body 9, or super 9, width dimension is affected by this. The frames are installed in a horizontal frame position, and are supported only by two extensions 7 of the frame top rail that extend beyond the main frame body and onto a notch 10 in the body 9, or super 9, top edges. The body or super is vertical walls with no top or bottom. They are stacked as high as the beekeeper feels comfortable, as high as the bees in the hive are able to maintain and fill the comb areas in the body or super, or as high as the beekeeper allows.

### Definitions

Horizontal frame position—Where the longest edge of the frame is substantially following the horizon or at an angle of less than 25 degrees from the horizon.

Vertical frame position—Where the longest edge of the frame is at an angle of 25 degrees or greater from the horizon.

Langstroth bee hive frame—A removable frame for use in a beehive type known as a Langstroth hive.

Mechanical Pry Point (MPP)—A notch in an edge or surface for locating a mechanical device to aid in separating a cover constituent or external object from the vertical frame orientation bee container.

W( )—the width, or smaller dimension, of the horizontal constituent. This is equivalent to the horizontal width, or smaller dimension, of a typical Langstroth body or super adjusted for eight or ten frame variations.

L( )—the length, or larger horizontal dimension, of the typical Langstroth body or super. This is approximately 19.875″+/−0.125″. The vertical frame orientation bee container uses this dimension for the length of the horizontal constituents 1a and also for the height of the vertical frame orientation bee container.

### SUMMARY OF THE INVENTION

A container is constructed with two vertical constituents 1b, and two horizontal constituents 1a. Two opposing ends are closed off with a cover constituent 5 over each end. Typically, the constituents are made of a wood material, however, any suitable material may be used such as plastics, laminates, composites, etc. as long as it will function in the keeping of bees. Inside the container, standard Langstroth style frames 6 are arranged in the vertical frame position. The frames are able to be accessed by removing, or opening, the covers 5 on each end. Normal spacing of the frames, as they would be used in a common Langstroth hive is maintained. As the frames are now accessible from the sides of the vertical frame orientation bee container, it is not necessary to remove the containers 9 above to gain access to the frames 6. Excess wear and tear, potential physical strain on the beekeeper, and disruption of the bee hive are significantly reduced. The horizontal constituents 1a have at least one opening 2 for the bees to pass through. The opening may be of any size that the bees may pass through with the preferred embodiment having a plurality of openings identically placed on all horizontal constituents 1a allowing passage.

### DRAWINGS DESCRIPTIONS

FIG. 1 is a perspective view of the vertical frame orientation bee container shown with the cover constituents offset.

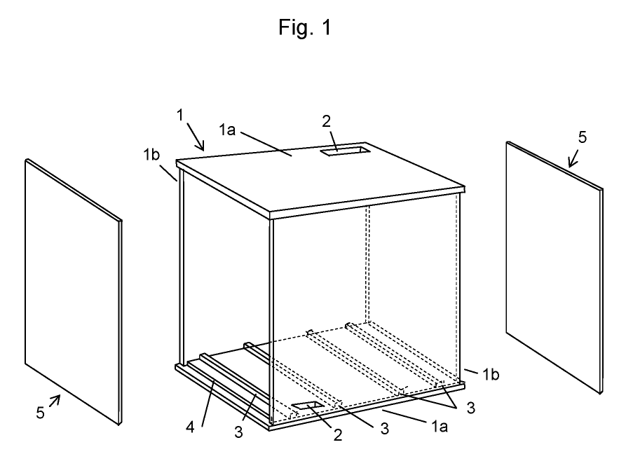

FIG. 2 is a perspective view of the vertical frame orientation bee container with a Langstroth style frame shown in the vertical frame position.

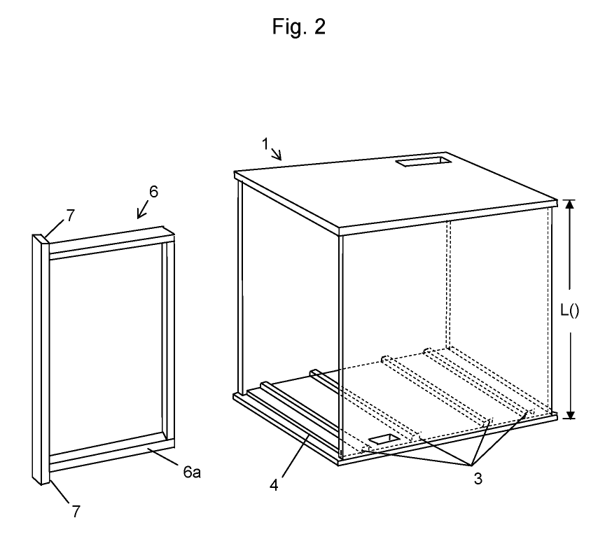

FIG. 3 is a perspective view of vertical constituent 1b with mechanical pry points shown in the best embodiment locations.

FIG. 4 is a perspective view of a typical Langstroth style body or super.

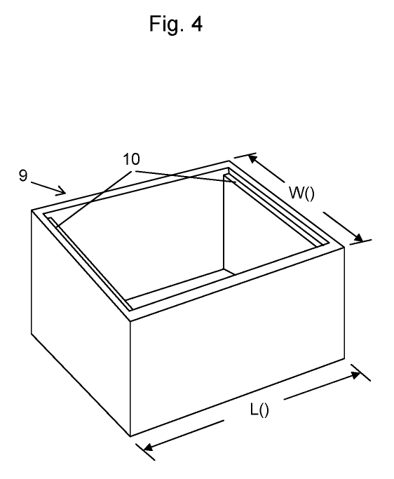

### DETAILED DESCRIPTION

A container with two vertical constituents 1b, two horizontal constituents 1a, and cover constituents 5 on each open end comprise the preferred embodiment.

The horizontal constituents contain at least one opening 2 to allow for bee movement through the horizontal constituents. The opening's longer sides run parallel to the vertical constituents in the preferred embodiment.

The vertical constituents 1b are typically solid but may have cut-outs on their surfaces, although iterations could be made with some, or none, of the cut-outs present. An example would be for hand-holds. Through-openings could be made in the constituents for various purposes.

The cover constituents 5 on each end are typically solid and removable. They may be hinged, sliding, etc., or secured by any convenient means. They may be secured closed by some means. The horizontal constituents 1a, in the preferred embodiment, have a plurality of spacing constituents 3, or a similar means of support, on them to maintain adequate spacing between the frames 6 and the horizontal constituents 1a. These should be attached to the horizontal constituents 1a by any appropriate means, or the spacers could be a part of the horizontal constituents 1a. The spacers 3 should raise the frame's end 6a 0.312″+0.05″/−0″ above the horizontal constituent 1a, in the preferred embodiment.

The horizontal constituents have at least one, or a plurality of, rabbet wall(s) 4 adjacent to each cover constituent 5 that allow the frame-top extensions 7 to be inserted into the container and execute a positive stop inside the container.

The best embodiment container is sized such that it will accept a plurality of standard Langstroth deep frames 6, and maintain the spacing of frames needed for bee keeping in a hive, while holding said frames in a vertical frame position, and dissuade the bees from building rogue comb.

The best embodiment container is sized such that it is externally dimensionally equivalent to a Langstroth hive body or super 9, based on the horizontal dimensions of a Langstroth hive, and accepting to most products for said hive type. The width dimension W( ) is subject to change due to the number of frames used. The external height and length of the best embodiment are L( ).

The vertical constituents 1b, covers 5, or horizontal constituents 1a may have a notch 8, or notches, in them, properly located on a surface or edge, such that the notch may be used as a tool locating point for prying off objects attached to, adjacent to, above, or below the container. These are referred to as a mechanical pry point (MPP).

The preferred embodiment vertical 1b and horizontal 1a constituents are made from 0.75″+/−0.03″ thick material. The cover constituents 5 in the preferred embodiment are 0.50″+/−0.05″ thick.

In the preferred embodiment, two horizontal constituents 1a and two vertical constituents 1b are connected; with the vertical constituents setting on a horizontal constituent. The outside edges will align with each other creating a flush surface. These constituents may be joined in any manor deemed appropriate for the strength required. The preferred embodiment would be glued, and screwed from two directions. Various joints may be used (butt, dove, lap, box, etc.) as deemed fit. The preferred embodiment would use a box joint. Each horizontal constituent 1a, in the best embodiment, receives four spacing constituents 3 evenly spaced to support the frames 6. These may be beveled if desired on the leading edges, although it is not strictly required. The spacers may be attached by any means deemed appropriate such as nails, glue, staples, etc. All mechanical fasteners should be flush or recessed, with neither end of the fastener protruding. Two covers 5 are required and are set into the recessed area at each end of the container. They should be substantially flush to the ends of the horizontal constituents 1a, and not extend past the vertical constituents 1b on either side. The covers 5 must be removable or movable, but may be affixed to the container by any means desired. The covers 5, in best practice, need to lock in place and be flush to the container around all four edges. Multiple iterations of the covers are possible, including width W( ) changes for frame quantity.

The container is loaded or unloaded with frames 6 from each end, after the covers 5 have been opened or removed allowing access. The frames 6 are moved out of the container until removed or into the container until the frame ends 7 engaging the rabbet wall 4 prevent further inward movement. All precautions regarding frame spacing, empty space, and other precautions for bee keeping are applicable. The frames 6 are standard frames for the Langstroth hive which are installed in the vertical frame position instead of in the horizontal frame position. The end 6a of the frame 6 will rest on the spacing constituents 3. Replacing and securing the cover 5 will prevent the frames 6 on the covered side from moving out of the rabbet area. The loading and unloading is identical for both sides of the container. Various devices may be used to space the frames as the bee keeper sees fit. With a symmetrical design, horizontal constituent 1a may be considered the top or bottom. By cutting a rabbet across the width of each end of the horizontal constituent 1a 1″ wide and 0.375″ deep and using the best embodiment height for the container, there is an appropriately sized space between the opposing bottoms of the frames 6 in the middle of the container using Langstroth deep frames 6. The vertical constituents 1b should cover the inner 0.50″ of the width of the rabbet cut to hold the frames in location. If frames 6 are used that do not provide the expected gap, which in the preferred embodiment would be 7 mm to 11 mm, then measures should be taken to fill any excessive space or remove any restrictive device or protrusion.

To create mechanical pry points notches 8 may be placed on the vertical constituents 1b, horizontal constituents 1a, or on the cover constituents 5 if desired. These may be a plurality or singular. They may be of any length, width, or depth as long as they fit the desired purpose. They should not extend inside of the container, or create a gap in the container closure on any edge. The preferred embodiment of a mechanical pry point would be at least one notch of reasonable length and depth on each horizontal 1a or vertical constituent 1b to allow a hive tool to be inserted and used to pry against a stuck top, body or super, or accessory device.

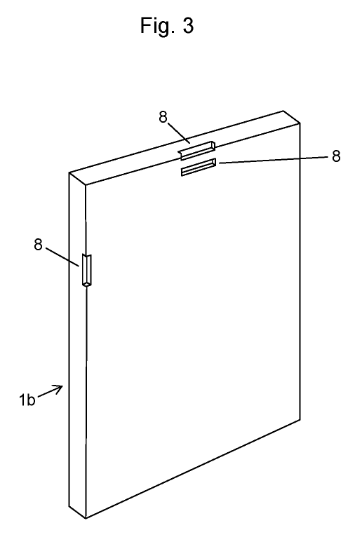

The preferred embodiment uses notches 0.20″ deep, 0.20″ wide and 2.5″ long. FIG. 3 shows a sample location, however, this is not the only manifestation that would be a suitable mechanical pry point.

By design, the Vertical Frame Orientation Bee Container will stack upon any appropriate Langstroth type body 9 or super 9 it is designed to work with, and vice versa, as well as be compatible with most appropriate Langstroth type devices. It will also be compatible with any other type of hive that will accept a Langstroth type hive body or super. The opening passing through the horizontal constituents 2 are sized such that a honey bee can pass through. The preferred embodiment uses an opening 0.375″ wide and 2.5″ long, with a pattern placing 5 openings evenly between each set of spacers, and between the vertical constituents. In less preferred embodiments, the opening's width, length, and quantity can be adjusted.

1. I claim a container for housing bees comprising:
a plurality of vertical constituents;
a plurality of horizontal constituents, with at least one through opening;
said constituents being assembled to form a container comprising two horizontal faces, two vertical faces, and two open faces on opposing vertical faces;
said container having means to hold at least one removable Langstroth bee hive frame with said removable Langstroth hive frame being in a vertical frame orientation; and
said Langstroth bee hive frame able to be placed in or removed from said container through either open face without the need to rotate, pivot or adjust said container on any axis from said container's conventional orientation.

2. A container for housing bees as in claim 1, wherein, there is at least one notch on a corner or surface allowing for the locating of a mechanical device to aid in separation of said container from an adjacent object.

3. A container for housing bees as in claim 1, wherein, there is a covering or covering device used to at least partially close or cover at least one open end of said container.
